(19) United States
(12) Patent Application Publication
(10) Pub. No.: US 2005/0283639 A1
(43) Pub. Date: Dec. 22, 2005

(54) Path analysis tool and method in a data transmission network including several internet autonomous systems

(76) Inventors: Jean-Francois Le Pennec, Nice (FR); Aurelien Bruno, Nice (FR); Nicolas Grisi, La Colle sur Loup (FR); Jean-Marie Sommerlatt, St Jeannet (FR)

Correspondence Address: S.H. Dworetsky;AT&T Corp., Room 2A-207, One AT&T Way, Bedminster, NJ, 07921, US

(21) Appl. No.: 10/638,445

(22) Filed: Aug. 11, 2003

(30) Foreign Application Priority Data
Dec. 27, 2002 (FR) 0216752

(51) Int. Cl. G06F 11/00

(52) U.S. Cl. 714/4

(57) ABSTRACT

Method for performing the analysis of the characteristics of a data path from a first data processing device to a second data processing device through a network comprising at least an autonomous system consisting in defining a scenario file the scenario to be used, such a scenario including the actions to be used, building a parameter file defining the parameters to be used in the actions, running at least one analysis module based upon the actions of the scenario file and the parameters of the parameter file, the analysis module calling at least a predefined information requesting procedure, and storing in at least an output file the data resulting from the running of the analysis modules

### TECHNICAL FIELD

The present invention relates to data transmission networks wherein it is necessary to perform the analysis of the network between a first data processing device such as a host and a second data processing device, such as a server, and relates in particular to a path analysis tool and method in a data transmission network including several Internet autonomous systems.

### BACKGROUND

Today, there is a need for the users and service providers in the Internet network to understand the behavior of the network which may be slow and congested and wherein the server access for processing a user request takes much time because the server is heavily loaded.

It is hard to diagnose a server problem remotely, but some basic tools can help to check out the network. The two standard functions used most often to debug networks are called Ping and Traceroute. Both tools originated under UNIX (trademark of Unix System Laboratories), but have spawned programs such as DOS and Windows (trademark of Microsoft corporation) that behave similarly (namely Ping and Tracert, which are available using the DOS command shell).

The ping function is based upon a special Internet Protocol (IP) packet called the Internet Control Message Protocol (ICMP) echo request packet used to send network information between two hosts. When the destination host receives the original echo request packet, it answers with an echo reply message placing the original echo request packet into the data field of the echo reply message. Ping is a useful tool to test the network connectivity and to measure whether the data packets are getting from a source host to a destination host and to give details about the path. Furthermore, ping enables measuring how long a data packet takes to get from one host to another host. The Traceroute function is a more sophisticated tool defining the router path a data packet is taking. In fact, Traceroute is a particularity of the ICMP Messages. One of these messages is returned to the source host when the Time To Live (TTL) field, which is decremented by one each time the message goes through a router, reaches zero. This means that the destination host is unreachable and, in such a case, it is necessary for the source host to process a reverse Domain Name Service (DNS) request. As the ping function, the Traceroute function provides a hop by hop response time, allowing determination of a bottleneck point in the network between two hops.

A type of bottleneck may be due to the packet Maximum Transmission Unit (MTU) which limits the length of a datagram that may be put in one physical frame. IP requires that each link has an MTU of at least 68 bytes. If any network provides a lower value than this, fragmentation and re-assembly must be implemented in the network interface layer in a way that is transparent to IP. IP implementations are not required to handle unfragmented datagrams larger than 576 bytes, but most implementations will handle larger values, typically slightly more than 8192 bytes or higher and rarely less than 1500. New technologies with tunnelling add overhead to incoming packets and therefore the packet size is bigger than the expected. This leads to MTU problems that need to be identified. These problems may impact not only latency but also packet delivery.

Some other Internet tools are very useful to troubleshoot a network problem. They include the Whois function, which can determine which company (or legal entity) is responsible for an IP address and can then group several IP addresses in one Autonomous System (AS) group. They include also the DNS function which allows making the link between the IP address and the hostname. The DNS as well as the Whois are able to determine who is the person responsible for an IP address.

But, at this time, none of the existing tools that include the above functions groups them in an efficient way to enable troubleshooting the problems raised in the data path through a network.

### SUMMARY OF THE INVENTION

Accordingly, the main object of the invention is to build a tool and achieve a method using information requesting procedures such as ping or Traceroute for analyzing a network behavior between a source data processing device, such a host, and a destination data processing device, such a server.

The invention relates therefore to a method for performing the analysis of the characteristics of a data path from a first data processing device to a second data processing device through a network comprising at least an autonomous system, the method consisting in defining in a scenario file the scenario to be used, such a scenario including the actions to be used, building a parameter file defining the parameters to be used in the actions, running at least one analysis module based upon the actions of the scenario file and the parameters of the parameter file, the analysis module calling at least a predefined information requesting procedure, and storing in at least an output file the data resulting from the running of the analysis modules.

According to another aspect, the invention relates to a path analysis tool for performing the analysis of a data path from a first data processing device to a second data processing device through a network comprising at least one autonomous system, the path analysis tool comprising a scenario file including a scenario defining the actions to be performed, a parameter file defining the parameters to be used in the actions, at least one analysis program module for performing the actions and using the parameters, the analysis program module calling at least one predefined information requesting procedure, and at least an output file for storing the data resulting from the running of the analysis modules.

### BRIEF DESCRIPTION OF THE DRAWINGS

The above and other objects, features and advantages of the invention will be better understood by reading the following more particular description of the invention in conjunction with the accompanying drawings wherein:

FIG. 1 is a schematic representation of a first network with several Internet autonomous systems wherein the invention can be implemented;

FIG. 2 is a schematic representation of a second network wherein the invention including a filtering device between two Internet autonomous systems can be implemented;

FIG. 3 is a schematic representation of a third network wherein the invention can be implemented including a server for aggregating the analysis results;

FIG. 4 is a block diagram of the path analysis tool according to the invention;

FIG. 5 is a flow chart representing the method according to the invention applied to the zone analysis;

FIG. 6 is a flow chart representing the method according to the invention applied to the delay analysis;

FIG. 7 is a flow chart representing the method according to the invention applied to the jitter analysis;

FIG. 8 is a flow chart representing the method according to the invention applied to the MTU analysis; and

FIG. 9 is a flow chart representing the method according to the invention applied to the throughput analysis.

### DETAILED DESCRIPTION OF THE INVENTION

FIG. 1 shows an example of a data transmission network wherein the invention is implemented between a first data processing device which is a host 10 and a second data processing device which is a server 12. Several networks or sub-networks may be interconnected between devices 10 and 12, such as Internet autonomous systems AS1 15, AS2 16 and AS3 17. It is assumed that, in the host, the client software is based on a proprietary application which performs the measurement and a legacy web browser allowing host 10 to visualize its measurement in a formatted manner. In server 12, several basic applications are grouped to provide the path analysis tool.

Several standard protocols and associated servers may be used to build the path analysis tool, including a Whois server 13 and a DNS server 14 which are attached to AS1 15. A certificate Authority CA 18 attached to AS2 16 may also be used to get characteristics of the data processing devices. CA allows providing trusted information inasmuch as this information is signed by organizations or companies. Note that DNS servers are less secure as they may be spoofed and do not contain all necessary information.

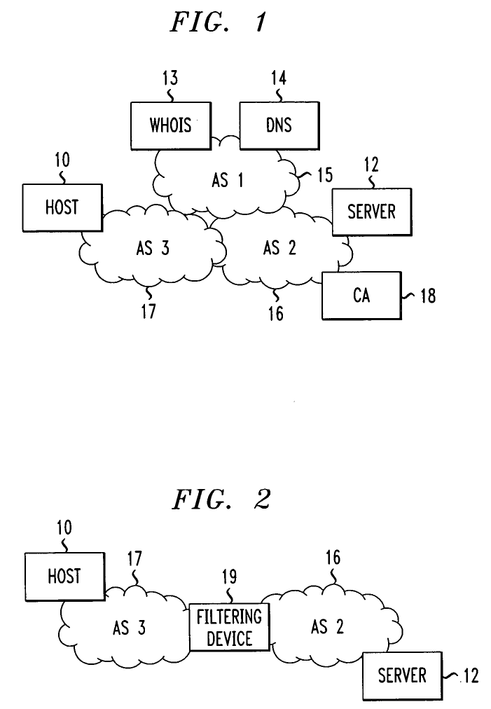

A case not covered by the current existing network analysis tools is illustrated in FIG. 2. A firewall 19 (or a filtering device) is present in the path between host 10 and server 12. This case is when one of the two devices (10) is attached to an autonomous system such as AS3 17 and the other one (12) is attached to another autonomous system such as AS2 16. The client server mode allows building simultaneously a half analysis from one peer (internal) to the firewall and another half analysis from the second peer to the firewall (external). The structured result can then easily reconstruct end-to-end analysis and provide results and statistics. This method can be used for all types of tests such as zone analysis, delay analysis, jitter analysis, MTU analysis and throughput analysis. Note that, in a general way, the software necessary to implement the method according to the invention could be shared between the source and the destination devices in other cases than the illustrated case with a firewall.

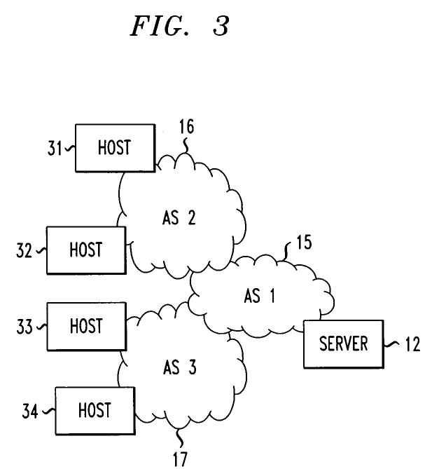

Another case illustrated in FIG. 3 is the aggregation of analysis results for several hosts, such as hosts 31, 32 attached to autonomous system 16, and hosts 33, 34 attached to autonomous system 17, performing the same kind of tests with the same server 12 attached to the same autonomous system or another autonomous system such as AS1 15. The analysis results can be easily aggregated thanks to a common structure for test generation and test results and a server correlation based on timestamp on the server side. Real time statistics may be provided to both devices and network administrators in exchanging dynamically the output files into which the results are stored.

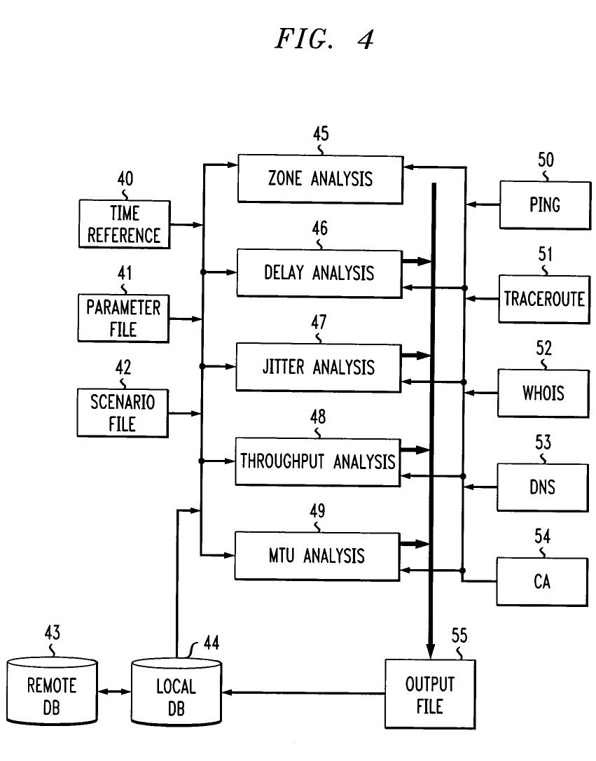

The path analysis tool according to the invention is illustrated in FIG. 4. Inputs for the tool are files that can be located locally on the local database DB 44 or remotely on a similar database located on one of the test servers, such as Remote DB 43. The two main necessary files —parameter 41 and scenario 42— can be located in these databases or can be files stored as regular files in the operating system of the user host. Files like output files stored in DB 43 or 44 can also be used as inputs for some tests as it will be described later. A last input may be a time reference Time Ref 40 used to provide time stamping for commands including one-way delay measurements. To work, the function needs to be available on the host or station and on the server.

Several types of analysis may be performed. The scenario file identifies which modules will be used within the analysis blocks. The scenario file may use one or several analysis blocks, each defining an analysis procedure. The currently defined analysis blocks include a zone analysis block 45, a Delay Analysis block 46, a Jitter Analysis block 47, a Throughput analysis block 48 and a MTU analysis block 49. Additional blocks may be added without major changes on the system which is modular. For example, a security analysis block may be added. This added block may use existing functions such as Certificate recovery form CA 54 or add new functions such as Authentication to a server. The proposed embodiment only addresses the performance test but the structure is open to any networking test.

An analysis block may contain several modules. For example, the zone analysis block includes a SortZone module used to group devices belonging to the same network or autonomous system. Another module is the Time To Live (TTL) calculator. This module uses the TTL field of the IP packet which is set to a relatively high number. As the packet goes through the network, the TTL field gets decreased by one by each router. When the TTL drops to 0, the packet is discarded by the router. Thus, the TTL can be used to determine approximately how many router hops the packet has gone through.

Another module is the Get module that is a cross analysis module that provides analysis with external data such as output files. This module is not shown as a block in the drawing but just with an arrow coming from database 44 to the analysis blocks. Similarly, the Put module allows storing information in a file like the output file or an intermediate file. Another common module is the timeout module which prevents a test from staying on hold.

External functions can be called by an analysis block. These functions are related to existing networking protocols and the call to a function results in packet generation on the network interface. A function which is often used is the ping function 50. Ping is a function that provides round-trip latency measurement of the sent packet and which depends mainly on the packet size and the class of service of the packet.

When pinging to a destination device, the function sends one ICMP echo request packet every second, for example, to the IP address of the device. When the ping program gets back an echo reply from the remote device, it prints out the response, giving several interesting pieces of information. The first one is the IP address of where it comes from (normally, the address of the destination device). The second one is the sequence number which indicates which ping packet got a reply (a skipped sequence number indicates a dropped packet). The third one is the Time To Live (TTL) field as mentioned above, and the fourth one is the time (in milliseconds) it took to get a reply. The ping parameters, such as packet parameters including packet length TOS (Type Of Service field included in the IP header) and the byte value which gives the Class of Service to use, are defined in the scenario file.

Another function often used is the Traceroute function 51 (Tracert) providing the identification of the IP address of nodes (devices) in the path up to the destination device. Several packets with different TTL values from 1 to N (N is the number of routers between the source and the destination devices) are successively sent to each router between the source and the destination devices. When the reply IP address is the same as the destination device address, this means that the destination device has been reached. Note that the IP address of the destination device can be determined by processing a single Domain Name Service (DNS) request to find the IP address from a hostname value.

Other functions illustrated in FIG. 4. are the Whois function 52 determining which company or legal entity is responsible for an IP address, DNS function 53 which allows making the link between the IP address and the hostname, and Certificate Authority (CA) function 54 providing the authentication of information contained in a digital certificate, all of which are functions used in the method according to the invention. But the list is not limited to these protocols. When necessary, other functions may be called, such as Telnet, FTP, Finger. Some of these functions require to get the list of devices to join in order getting the information which can be stored in a file (e.g. Whois, DNS, CA).

Finally, the results of each analysis are used to create or to modify at least an output file 55 that is defined in scenario file 42. The details of such an output file are given hereafter.

The following grammar in XML language of the scenario file explains the structure of each field and each internal command. Note that XML is not mandatory, but the use of structured files for input and output files simplifies and improves the tool, making it easy to interface with other softwares.

```
input ::= < input >
            [ action ]*
        </input >
action ::= < action [ attributes ] />
attributes ::= [ name || dolt || serverDest || TracerouteFileName || hosts ||
timeOut || whoisFileName || SortZonesFileName ]*
name := String
dolt ::= Bool
serverDest ::= String // peering point to test tester.
fileName ::= String // OUTPUT FILE name.
hosts ::= String [ ] // “whois” server list
timeOut ::= int
```

Thus, the following example is a zone analysis for a device followed by a delay analysis based on a defined sequence of pings for all nodes in the path to the destination device which is a web server.

```
< input >
< action name=‘Traceroute’ dolt=‘0’ serverDest=‘www.att.com’
                fileName=‘TracerouteFile’ />
< action name=‘testTracerouteFile’ dolt=‘1’ fileName=‘TracerouteFile’ />
< action name=‘whois’ dolt=‘1’ hosts=‘[h1 h2]’ timeOut=‘t’
                fileName=‘whoisFile’ />
< action name=‘SortZones’ dolt=‘1’ fileName=‘SortZonesFile’ />
< action name=‘param.xml’ filename=‘param.xml’ />
</input >
```

In the above example, the analysis is made thanks to the traceroute and Whois functions and the SortZone module as a first step and then ping as the second step when the scenario is involved. But a more complex mechanism may be added if necessary, such as the advanced Traceroute module.

Two output files for writing test results are created in this example: a Whois file which will contain the details for each node for which the Whois actions have been performed and a SortZone file which will contain the results of the aggregation by the provider.

The other input file, that is the parameter file, provides flexibility in providing easy access to the parameters and sequencing of functions to the user. Predefined parameter files can be used or modified for specific needs. This file defines which kinds of packets are to be sent, which size each packet will be and which timing will be used. Thus, the ping command may be used in burst mode, and a module is then used to define the parameters to apply to the ping function. Burst is a module that may be invoked in delay analysis, in jitter analysis or in throughput analysis.

The characteristics of a burst in the ping function defined in the following grammar includes the space between bursts called “period” and the space between pings in a burst called “burst space”.

```
test ::= < test >
        [ parameter ]+
    </ test >
parameter::= < parameter index exec_nb next_index >
                [ burst ]*
        </ parameter >
burst ::= < burst index taille espacement_des_bursts period />
index ::= int
exec_nb ::= int
next_index ::= int
size ::= int
bursts_space::= [ Day & Hour & Minute & Second & MilliSecond ]
Day ::= [1..31]
Hour ::= [0..23]
Minute ::= [0..59]
Second ::= [0..59]
MilliSecond ::= [0..99]
period ::= int
```

The following parameter file shows an example of several bursts being configured with different timings and different packet sizes.

```
< test >
    < parameter index=‘0’ next_index=‘0’ >
    </ parameter >
    < parameter index=‘1’ exec_nb=‘1’ next_index=‘i’ >
          < burst index=‘1‘ size=‘10’ bursts_space=‘t11’ period=‘T11’
/>
            .
            .
          < burst index=‘p’ size=‘100’ bursts_space=‘t1p‘
period=‘T1p’ />
    </ parameter >
    < parameter index=‘j’ exec_nb=‘3’ next_index=‘k’ >
          < burst index=‘1‘ size=‘12’ bursts_space=‘t1j’ period=‘Tj1’
/>
            .
            .
          < burst index=‘p‘ size=‘102’ bursts_space=‘tjp‘
period=‘Tjp’ />
    </ parameter >
</ test >
```

The output file contains the results of the analysis which are structured in a predefined manner in order to be easily presented to the user thanks to a web browser. An output file grammar is defined for each kind of test. Thus, the following grammar is given for delay measurement structured by zones.

```
stats ::= < stats >
        [ action ]+
    < /stats >
action ::= < action [ attributes ] >
            [ result ]+ || [ group ]+
        < /action >
result ::= < result [ attributes ] />
group ::= < group [ attributes ] >
            [ result ]+
        < /group >
attributes ::= [ index || host || value || timeout || name || domain ||
      nbHosts || packetSize || timeStamp || period || pingIn
      || pingOut || crossTime || ttl || ]*
name ::= String || ‘unresolved’
value ::= String || ‘unresolved’
index ::= Int
host ::= String
timeOut ::= Int
domain ::= String || ‘unresolved’
nbHosts ::= Int
packetSize ::= Int
timeStamp ::= [ Day & Hour & Minute & Second & MilliSecond ]
Day ::= [1..31]
Hour ::= [0..23]
Minute ::= [0..59]
Second ::= [0..59]
MilliSecond ::= [0..99]
period ::= int
pingIn ::= int || ‘unresolved’
pingOut ::= int || ‘unresolved’
crossTime ::= int || ‘unresolved’
ttl ::= int
```

For each test, detailed results can be stored or only aggregated results or both. So, each action corresponding to a call of an external function or an internal function from a module of an analysis block may be defined as a function having outputs. Output information of each action as standard results or advanced computation can have several attribute fields as defined in the output grammar.

As an example, the following output file example shows a first action Traceroute providing just a list of IP addresses corresponding to the nodes in the path. Then, the Whois action provides the network to which each IP address or host name belongs. A third action, SortZone, defines which are the first and last nodes in the path in the corresponding networks, including the number of hops on each network. A last action is the ping action (in burst mode) providing statistics by zone.

```
< stats >
< action name=‘Traceroute’ host=‘host1’ >
            < result index=‘1’ value=‘@IP1’ />
            < result index=‘n’ value=‘@IPn’ />
  < /action >
  < action name=‘whois’ >
            < result index=‘1’ host=‘host1’ timeout=‘timeout1’
value=‘NET1’ />
    < result index=‘n’ host=‘hostn’ timeout=‘timeoutn’ value=‘NET2’ />
  < /action>
  < action name=‘SortZones’ >
    < group name=‘zone1’ index=‘1’ domain=‘NET1’ nbHops=‘h1’ >
            < result name=‘entry’ value=‘@IP11’ />
            < result name=‘exit’ value=@IP12’ />
    < /group >
    < group name=‘zonej’ index=‘j’ domain=‘NET2’ nbHops=‘hj’ >
            < result name=‘entry’ value=‘@IPj1’ />
            < result name=‘exit’ value=@IPj2’ />
    < /group >
  < /action >
  < action name=‘pings’ timeout=‘t’ pktSize=‘p’ timeStamp=‘ts1’
  period=‘T’ >
    < group name=‘statsZone1’ ttl=‘ttl1’ >
            < result index=‘1’ pingIn=‘t111’ pingOut=‘t112’
crossTime=‘t112−t111’ />
            < result index=‘i’ pingIn=‘t1i1’ pingOut=‘t1i2’
crossTime=‘t1i2−t1i1’ />
    < /group >
    < group name=‘statsZonej’ ttl=‘ttlj’ >
            < result index=‘1’ pingIn=‘tj11’ pingOut=‘tj12’
crossTime=‘tj12−tj11’ />
            < result index=‘i’ pingIn=‘tji1’ pingOut=‘tji2’
crossTime=‘tji2−tji1’ />
    < /group >
  < /action >
  < action name=‘pings’ timeout=‘t’ pktSize=‘p’ timeStamp=‘ts1’
  period=‘T’ >
    < group name=‘statsZone1’ ttl=‘ttl1’ >
            < result index=‘1’ pingIn=‘t111’ pingOut=‘t112’
crossTime=‘t112−t111’ />
            < result index=‘i’ pingIn=‘t1i1’ pingOut=‘t1i2’
crossTime=‘t1i2−t1i1’ />
            < /group >
    < group name=‘statsZonej’ ttl=‘ttlj’ >
            < result index=‘1’ pingIn=‘tj11’ pingOut=‘tj12’
crossTime=‘tj12−tj11’ />
            < result index=‘i’ pingIn=‘tji1’ pingOut=‘tji2’
crossTime=‘tji2−tji1’ />
    < /group >
  < /action >
< /stats >
```

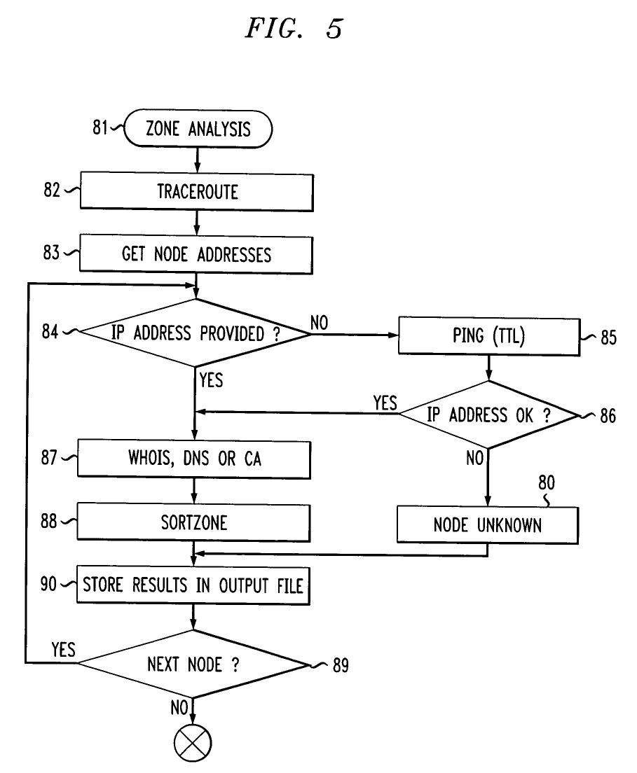

Now, examples of the analysis procedures shown in FIG. 4 are illustrated by the flow charts of FIG. 5 to FIG. 9. In reference to FIG. 5, the zone analysis provides detailed identification of the devices and is able to group devices according to their IP addresses, or their autonomous system ownership in order to simplify the topology and to provide further measurements associated with each group. The analysis, initialized at step 81, starts by the Traceroute action at step 82 that provides in return at step 83, the addresses of the nodes in the path which will be identified one by one. Nodes not discovered because masked and not answering may be identified using the advanced Traceroute function which uses other means. This corresponds to a NO answer at step 84 followed by a ping (TTL) 85 which will set the TTL in the ping command to the hop number corresponding to the not answering device. Generally, devices should answer to packets when the TTL is reached which would be the case even if they refuse to answer to ICMP messages (ping). If the IP address is discovered this way or through the first Traceroute, the process continues at step 87 where more details are asked for, thanks to a request using either Whois, DNS or CA or several of these functions. If the IP address is not recognized at step 86, the node is marked as unknown at step 80. After identification, the IP addresses are sorted by network or zone at step 88. Information on identified and non identified devices are stored in one output file at step 90 and the process either ends or continues with the next node if it is not the last in the node address list, thanks to the loop at step 89 back to step 84.

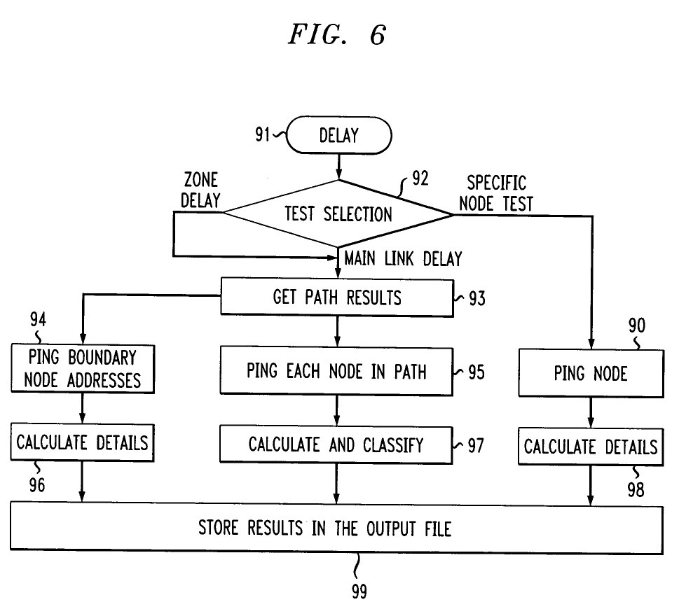

Referring to FIG. 6, the delay analysis provides the round-trip or one-way delay measurement with packets, the selected parameters of which include the packet length, the class of service, the protocol and the packet sequencing. The process initialized at step 91 has three main test modes selected at step 92. Aa simple specific node test can be performed and then, based on the parameter file, a ping or sequence of pings is generated at step 90. The ping answers are used to take measurements and possibly calculate requested statistics at step 98. Then, based on the scenario file, the results are stored in the defined output file at step 99. A main link delay analysis or a zone delay analysis can be achieved for which path results done by a zone analysis should be recovered (step 93) from the appropriate file(s).

The delay analysis then continues at step 94 where all network or sub-network boundary nodes are pinged with parameters defined by the parameter file used. The reception of ping packets provides information that can be used to calculate requested information on delay at step 96 which is then stored in an output file at step 99.

The main difference for the main link delay calculation is that a ping or sequence of pings is sent to all nodes in the path at step 95 and then the delay measurement is done at step 97 by delta round-trip calculation between two consecutive nodes. The classification of nodes may also be provided at this stage depending on the request defined in the scenario file. The last step 99, as for the other analysis, is to store the results in an output file.

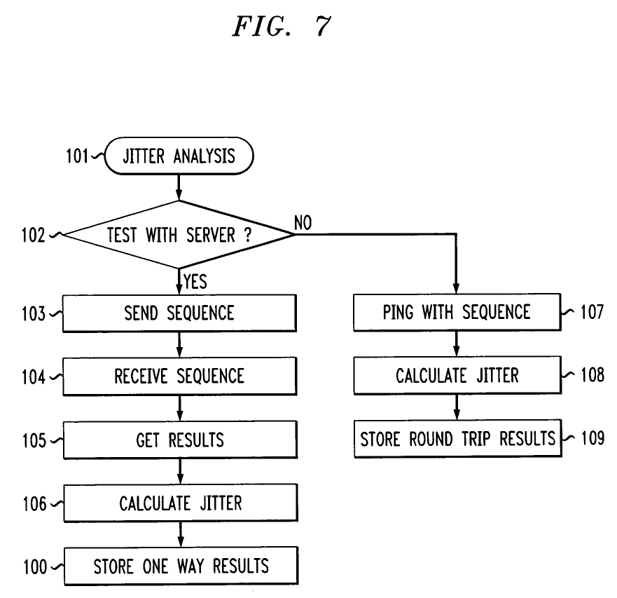

Referring to FIG. 7, the Jitter analysis provides the round-trip or one-way jitter measurement with packets, the selected parameters of which include the packet length, the class of service, the protocol and the packet sequencing. The process initialized at step 101 has two main modes selected at step 102, depending on whether the test is performed with the test server as destination or with a normal device. Without a server, a sequence of pings, generally a set of bursts, is generated at step 107 to identify the variation in latency which will provide the jitter by delta calculation at step 108. Results from the pings or the calculated roundtrip Jitter are stored in an output file at step 109.

With a server, the same sequence of pings can be sent at step 103; but as the server is proprietary, other protocols than ICMP can be used, for example, the test can be performed with TCP or UDP over IP. The server will intercept these packets and will rebuild a similar sequence using the same parameter file. Either the scenario is predefined or the station starting the test sends its scenario to the server prior to the test. So, the server sends the same sequence back to the station which will be received at step 104. The method steps in the server are not shown as they are similar to the ones in the station. The server can do the test in parallel on its side. The station then requests the results of the first sequence to the server and gets associated results at step 105. The results will provide the jitter for the path from the station to the server while the received sequence provides the jitter for the path from the server to the station after calculation at step 106. The last step 100 is to store both one-way results into an output file (shown in FIG. 4).

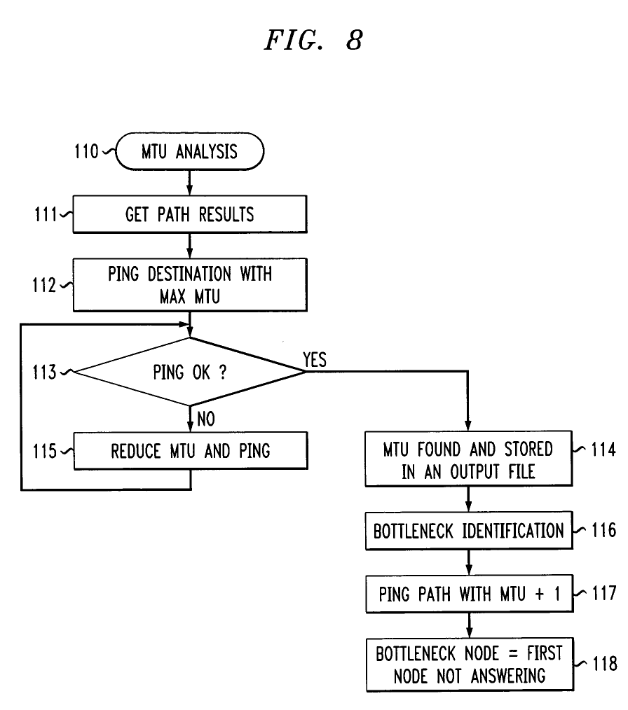

Referring to FIG. 8, the MTU (Maximum Transmission Unit) analysis provides the MTU measurement from end to end with the capability to identify the device in the path limiting the MTU. The process initialized at step 110 in its full mode starts with getting path results at step 111 obtained by a previous path analysis. This is necessary when the bottleneck identification process is also defined in the scenario file containing the request. Otherwise, step 111 can be bypassed. The next step 112 is the ping of the destination device with the expected Max MTU value also defined in the parameter file. If an answer is received, then step 113 branches to step 114 and the MTU is found and stored in an output file (shown in FIG. 4).

If no answer is received to the ping, a timeout at step 113 branches to step 115 where the MTU is reduced to a value defined in the parameter file. The method can be either a dichotomist test or a decrease of the MTU value corresponding to a decrease of the ping packet length. Then, step 115 loops back to step 113 and waits for an answer.

If bottleneck identification is done at step 116, which can be the case for any MTU not being the max MTU or for a MTU under a defined value, a ping is sent to each node in the path with a value just above the MTU found at step 117. The first node not answering (or the last answering from the source) identifies the bottleneck node at step 118. The information is stored in an output file and will help to improve the network behavior by further investigation.

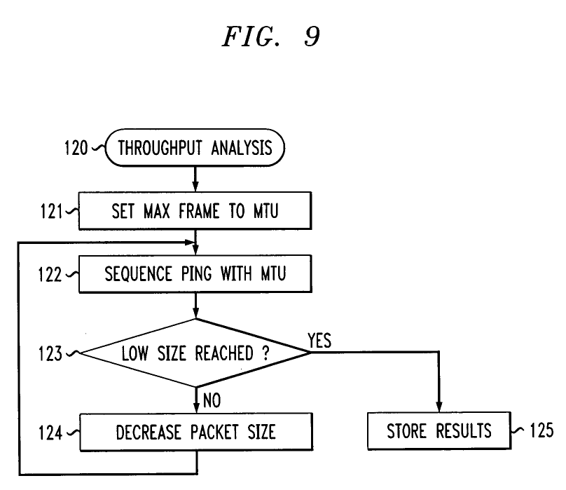

Referring to FIG. 9, the throughput analysis provides the round-trip or one way throughput measurement with packets, the selected parameters of which include the packet length, the class of service, the protocol and the packet sequencing. The process initialized at step 120 allows measuring the behavior of the network depending of packet size and number of packets sent. The described process, using the ping procedure, works with any accessible device in the network, while an improved mechanism can only be used with the test server since another protocol than ping is, in that case, used for the test such as UDP/IP, TCP/IP, FTP, HTTP . . .

The throughput analysis is more efficient if it starts with packets from the maximum size so the MTU calculation will help to define this value which can be an input for this analysis.

In that case, the max frame size is set to this MTU value at step 121 and then a sequence of packets (ping generally) defined in the parameter file are sent to the destination at step 122. If only large packets are sent, this provides the maximum throughput but does not give all network characteristics so that the preferred test is to continue after the first sequence of packets to send smaller packets in decreasing the size. This is an option in the scenario file. In that case, the first access to step 123 will see that the low limit of packet size is not reached and then, at step 124, the packet size is decreased before resending a full test sequence. When the low limit is reached, step 123 jumps to step 125 where the results are stored in an output file.

While this invention has been described in a preferred embodiment, other embodiments and variations can be effected by a person of ordinary skill in the art without departing from the scope of the invention.

1-30. (canceled)

31. A method of performing an analysis of characteristics of a data path from a first data processing device to a second data processing device through a network, the method comprising:
defining in a scenario file, the scenario to be used, the scenario comprising the actions to be implemented;
building a parameter file defining the parameters to be used in the actions;
running an analysis program module based on the actions of the scenario file and the parameters of the parameter file, the module calling a predefined information requesting procedure; and
storing in an output file the data resulting from running the analysis program module.

32. A method according to claim 31, wherein the analysis program module is included in an analysis procedure identified by the scenario file.

33. A method according to claim 32, wherein the analysis procedure is a zone analysis for providing detailed identification of devices and for grouping the devices according to their IP addresses, or their autonomous system ownership, in order to simplify the topology and to provide further measurements associated with each group.

34. A method according to claim 32, wherein the analysis procedure is a delay analysis for providing a round-trip or a one-way latency measurement with packets, the parameters comprising packet length, class of service, protocol and packet sequencing.

35. A method according to claim 32, wherein the analysis procedure is a jitter analysis for providing a round-trip or a one-way jitter measurement with packets, the parameters comprising packet length, class of service, protocol and packet sequencing.

36. A method according to claim 32, wherein the analysis procedure is a throughput analysis for providing a round-trip or a one-way throughput measurement with packets, the parameters comprising packet length, class of service, protocol and packet sequencing.

37. A method according to claim 32, wherein the analysis procedure is an MTU analysis for providing an MTU measurement from end to end and having the ability to identify a device in a path limiting the MTU.

38. A method according to claim 32, wherein the information requesting procedure is a ping function for providing a round-trip latency measurement of a packet.

39. A method according to claim 32, wherein the information requesting procedure is a Traceroute function for providing IP addresses of nodes in the path up to the second data processing device.

40. A method according to claim 32, wherein the information requesting procedure is a Whois function for determining an owner of an IP address.

41. A method according to claim 32, wherein the information requesting procedure is a DNS function for associating a link between an IP address and a hostname.

42. A method according to claim 32, wherein the information requesting procedure is a certificate authorizing function for providing an authentication of information contained in a digital certificate.

43. A method according to claim 42, wherein the data resulting from the running of a previous analysis program module is stored the output file and used by a subsequent analysis program module.

44. A method according to claim 43, wherein the network includes two autonomous systems interconnected by a firewall, a first half analysis being performed by the first data processing device for the path between the first data processing device to the firewall and a second half analysis being performed by the second data processing device for the path between the second processing device and the firewall.

45. Method according to claim 43, wherein several analyses are performed for paths between several hosts which are connected to one or more autonomous systems and a server, the results of all analyses being aggregated by the server.

46. A system for performing an analysis of a data path from a first data processing device to a second data processing device, the data path being within a network, the system comprising:
a server;
a database in communication with the server;
a scenario file having a scenario defining actions to be performed and stored within the database;
a parameter file having parameters to be used in performing the actions and stored within the database;
an analysis program module for calling a predefined information requesting procedure and stored within the database; and
an output file for storing data resulting from the running of the analysis program module, the output file being stored within the database.

47. The system of claim 46, wherein the analysis program module is included in an analysis procedure identified by the scenario file.

48. The system of claim 47, wherein the analysis procedure is a zone analysis for providing detailed identification of devices and for grouping the devices according to their IP addresses, or their autonomous system ownership, in order to simplify the topology and to provide further measurements associated with each group.

49. The system of claim 47, wherein the analysis procedure is a delay analysis for providing a round-trip or a one-way latency measurement with packets, the parameters comprising packet length, class of service, protocol and packet sequencing.

50. The system of claim 47, wherein the analysis procedure is a jitter analysis for providing a round-trip or a one-way jitter measurement with packets, the parameters comprising packet length, class of service, protocol and packet sequencing.

51. The system of claim 47, wherein the analysis procedure is a throughput analysis for providing a round-trip or a one-way throughput measurement with packets, the parameters comprising packet length, class of service, protocol and packet sequencing.

52. The system of claim 47, wherein the analysis procedure is an MTU analysis for providing an MTU measurement from end to end and having the ability to identify a device in a path limiting the MTU.

53. The system of claim 47, wherein the information requesting procedure is the ping function for providing a round-trip latency measurement of a packet.

54. The system of claim 47, wherein the information requesting procedure is a Traceroute function for providing IP addresses of nodes in the path up to the second data processing device.

55. The system of claim 47, wherein the information requesting procedure is a Whois function for determining an owner of an IP address.

56. The system of 47, wherein the information requesting procedure is a DNS function for associating a link between an IP address and a hostname.

57. The system of claim 47, wherein the information requesting procedure is a certificate authorizing function for providing an authentication of information contained in a digital certificate.

58. The system of claim 47, wherein the data resulting from the running of a previous analysis program module is stored the output file and used by a subsequent analysis program module.

59. The system of claim 47, wherein the network includes two autonomous systems interconnected by a firewall, a first half analysis being performed by the first data processing device for the path between the first data processing device to the firewall and a second half analysis being performed by the second data processing device for the path between the second processing device and the firewall.

60. The system of claim 58, wherein several analyses are performed for paths between several hosts which are connected to one or more autonomous systems and a server, the results of all analyses being aggregated by the server.
